(19) United States
(12) Patent Application Publication
(10) Pub. No.: US 2021/0231268 A1
(43) Pub. Date: Jul. 29, 2021

(54) LED-BASED LIGHT WITH CANTED OUTER WALLS

(71) Applicant: iLumisys, Inc., Troy, MI (US)

(72) Inventors: James M. Amrine, JR., Ann Arbor, MI (US); John Ivey, Farmington Hills, MI (US)

(21) Appl. No.: 17/230,754

(22) Filed: Apr. 14, 2021

Related U.S. Application Data
(63) Continuation of application No. 16/907,590, filed on Jun. 22, 2020, now Pat. No. 11,028,972.
Application No. 16/907,590 is a continuation of application No. 16/223,762, filed on Dec. 18, 2018, now Pat. No. 10,690,296.
Application No. 16/223,762 is a continuation of application No. 14/826,505, filed on Aug. 14, 2015, now Pat. No. 10,161,568.
(60) Provisional application No. 62/169,050, filed on Jun. 1, 2015.

(51) Int. Cl. F21K 9/27; F21V 23/02; F21V 19/00; F21V 23/06; F21V 3/02; F21K 9/66

(52) U.S. Cl. CPC F21K 9/27; F21V 23/023; F21V 19/003; F21V 17/104; F21V 3/02; F21K 9/66; F21V 23/06

(57) ABSTRACT

An LED-based light has an elongate housing having a longitudinal axis and a vertical axis, the housing defined by a base and two canted outer walls meeting opposite the base, the housing defining a cavity. An LED circuit board on which a plurality of LEDs are located is positioned within the cavity. End caps are positioned at opposite ends of the housing.

### CROSS REFERENCE TO RELATED APPLICATION

This application is a continuation of U.S. application Ser. No. 16/907,590, filed Jun. 22, 2020, which is a continuation of U.S. application Ser. No. 16/223,762, filed Dec. 18, 2018, now U.S. Pat. No. 10,690,296, issued Jun. 23, 2020, which is a continuation of U.S. application Ser. No. 14/826,505, filed Aug. 14, 2015, now U.S. Pat. No. 10,161,568, issued Dec. 25, 2018, which claims priority to U.S. Provisional Patent Application Ser. No. 62/169,050, filed on Jun. 1, 2015. The contents of all of the prior applications are incorporated here by reference in their entirety.

### TECHNICAL FIELD

The embodiments disclosed herein relate to a light emitting diode (LED)-based light for replacing a fluorescent light in a standard fluorescent light fixture.

### BACKGROUND

Fluorescent lights are widely used in a variety of locations, such as schools and office buildings. Although conventional fluorescent lights have certain advantages over, for example, incandescent lights, they also pose certain disadvantages including, inter alia, disposal problems due to the presence of toxic materials within the light.

LED-based lights designed as one-for-one replacements for fluorescent lights have appeared in recent years.

### SUMMARY

Disclosed herein are embodiments of LED-based lights. One embodiment of an LED-based light has an elongate housing having a longitudinal axis and a vertical axis, the housing defined by a base and two canted outer walls meeting opposite the base, the housing defining a cavity. An LED circuit board on which a plurality of LEDs are located is positioned within the cavity. End caps are positioned at opposite ends of the housing.

Another embodiment of an LED-based light has an elongate housing having longitudinal axis and a vertical axis, the housing defining a cavity having a width that varies along the vertical axis, the width including a greatest width below a vertical center of the vertical axis. An LED circuit board on which a plurality of LEDs are located is positioned within the housing. End caps are positioned at opposite ends of the housing.

Another embodiment of an LED-based light comprises an elongate housing comprising a base extending substantially along a horizontal and two canted outer walls extending from the base and canting toward each other, wherein a portion of a profile of each of the two canted outer walls between a line tangent to the profile and 45° from horizontal and a line tangent to the profile and 90° from the horizontal is greater than 30 percent, the housing defining a cavity. An LED circuit board on which a plurality of LEDs is positioned within the cavity. An end cap is located at each end of the housing.

### BRIEF DESCRIPTION OF THE DRAWINGS

The various features, advantages and other uses of the present apparatus will become more apparent by referring to the following detailed description and drawings in which:

FIG. 1 is a partial perspective view of a first example of an LED-based light including an LED circuit board, a housing for the LED circuit board and a pair of end caps positioned at the ends of the housing;

FIG. 2A is a perspective partial assembly view of the LED-based light of FIG. 1 with the end caps removed, showing the LED circuit board and a power supply circuit board;

FIG. 2B is an enlarged view of an end cap removed from the housing;

FIGS. 3A-C are additional views of one of the pair of end caps of the LED-based light of FIG. 1;

FIG. 4 is a plan view showing an example installation of the LED-based light of FIG. 1 and the LED-based light of FIG. 7 in a light fixture;

FIG. 5 is a cross section of the LED-based light of FIG. 1 taken at a position similar to the line A-A in FIG. 1;

FIG. 6 is an example of a polar light distribution curve for the LED-based light of FIG. 1, shown with reference to the polar light distribution curve for a conventional LED-based light;

FIG. 7 is a partial perspective view of a second example of an LED-based light including an LED circuit board, a housing for the LED circuit board and a pair of end caps positioned at the ends of the housing;

FIG. 8A is a perspective partial assembly view of the LED-based light of FIG. 7 with the end caps removed, showing the LED circuit board and a power supply circuit board;

FIG. 8B is an enlarged view of an end cap removed from the housing;

FIGS. 9A-C are additional views of one of the pair of end caps of the LED-based light of FIG. 7;

FIG. 10 is a cross section of the LED-based light of FIG. 7 taken at a position similar to the line B-B in FIG. 7;

FIG. 11 is an example of a polar light distribution curve for the LED-based light of FIG. 7, shown with reference to the polar light distribution curve for a conventional LED-based light;

FIGS. 12A-H are cross sections of alternative examples of LED-based lights;

FIG. 13A is a cross section of the housing illustrating that 30% or greater of the profile of a canted outer wall is between a line tangent to the profile and 45° from horizontal and a line tangent to the profile and 90° from the horizontal;

FIG. 13B is a cross section of a conventional housing having a circular cross section, illustrating that only 25% of the profile of the circular housing is between a line tangent to the profile and 45° from horizontal and a line tangent to the profile and 90° from the horizontal; and

FIG. 14 is an example of light intensity projected onto the internal surface of the housing for the LED-based light of FIG. 10, shown with reference to the housing and the LEDs.

### DETAILED DESCRIPTION

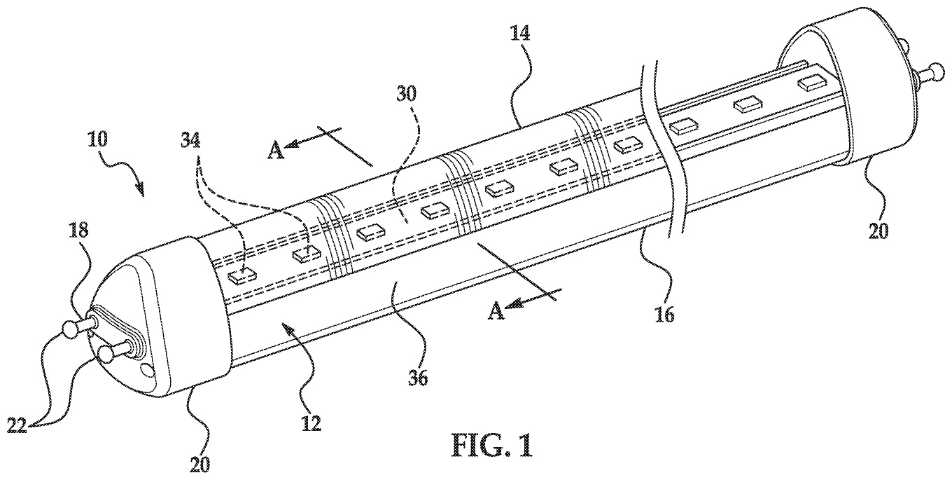

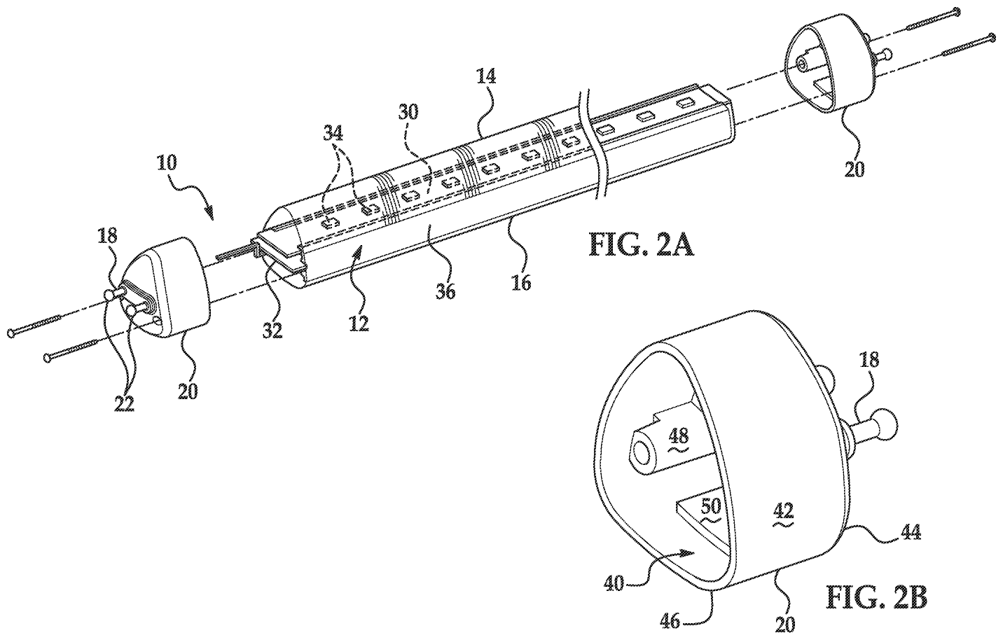

A first example of an LED-based light 10 for replacing a conventional light in a standard light fixture is illustrated in FIGS. 1 and 2A. The LED-based light 10 includes a housing 12 and has a pair of end caps 20 positioned at the ends of the housing 12. An LED circuit board 30 including LEDs 34, a power supply circuit board 32 and a support 36 are arranged within the housing 12.

The housing 12 of the LED-based light 10 can generally define a single package sized for use in a standard fluorescent light fixture. In the illustrated example, the pair of end caps 20 is attached at opposing longitudinal ends of the housing 12 for physically connecting the LED-based light 10 to a light fixture. As shown, each end cap 20 carries an electrical connector 18 configured to physically connect to the light fixture. The electrical connectors 18 can be the sole physical connection between the LED-based light 10 and the light fixture. One example of a light fixture for the LED-based light 10 is a troffer designed to accept conventional fluorescent lights, such as T5, T8 or T12 fluorescent tube lights. These and other light fixtures for the LED-based light 10 can include one or more sockets adapted for physical engagement with the electrical connectors 18. Each of the illustrated electrical connectors 18 is a bi-pin connector including two pins 22. Bi-pin electrical connectors 18 are compatible with many fluorescent light fixtures and sockets, although other types of electrical connectors can be used, such as a single pin connector or a screw type connector.

The light fixture can connect to a power source, and at least one of the electrical connectors 18 can additionally electrically connect the LED-based light 10 to the light fixture to provide power to the LED-based light 10. In this example, each electrical connector 18 can include two pins 22, although two of the total four pins can be “dummy pins” that provide physical but not electrical connection to the light fixture. The light fixture can optionally include a ballast for electrically connecting between the power source and the LED-based light 10.

The housing 12 is an elongate, light transmitting tube at least partially defined by a lens 14 opposing the LEDs 34. The term “lens” as used herein means a light transmitting structure, and not necessarily a structure for concentrating or diverging light. While the illustrated housing 12 is linear, housings having an alternative shape, e.g., a U-shape or a circular shape can alternatively be used. The LED-based light 10 can have any suitable length. For example, the LED-based light 10 may be approximately 48″ long, and the housing 12 can have a 0.625″, 1.0″ or 1.5″ diameter for engagement with a standard fluorescent light fixture.

The housing 12, as generally shown, can be formed as an integral whole including the lens 14 and a lower portion 16. The lens 14 can be made from polycarbonate, acrylic, glass or other light transmitting material (i.e., the lens 14 can be transparent or translucent). The lower portion 16 can be made from the same polycarbonate, acrylic, glass or other light transmitting material as the lens 14, or, can be made of a similar opaque material. The housing 12 may be formed by extrusion, for example. Optionally, the lens 14, made from a light transmitting material, can be coextruded with a lower portion made from opaque material to form the housing 12. Alternatively, the housing 12 can be formed by connecting multiple individual parts, not all of which need be light transmitting.

The support 36 is arranged within the housing 12. The support 36, as generally shown, is elongate and may support one or both of the LED circuit board 30 and the power supply circuit board 32 inside of the housing 12.

In the illustrated example of the LED-based light 10, the support 36 can additionally support, in whole or in part, the end caps 20, the housing 12, or both. With reference to FIG. 2B, each of the end caps 20 defines a socket 40 sized and shaped to receive and retain an end of the housing 12. The attachment of the end caps 20 at the opposing ends of the support 36 fixes the position and orientation of the sockets 40 to retain the housing 12 in its arrangement around the support 36, the LED circuit board 30 and the power supply circuit board 32. The end caps 20 may, as shown, be attached to the opposing ends of the support 36 by threaded fasteners, for example. The ends of the housing 12 can have a recess around a circumference of the ends so that exterior surfaces of the end caps 20 are flush with the exterior surface of the housing 12.

In the illustrated example in FIG. 2B, each of the end caps 20 is generally tubular, with an annular sidewall 42, a first, closed end 44 bordering the electrical connector 18 and a second, open end 46 in communication with the socket 40. The socket 40 may, as shown, be defined in part by the interior of the annular sidewall 42. According to this example, the interior of the annular sidewall 42 is generally sized and shaped to receive and circumscribe the exterior of an end of the housing 12. Additionally, or alternatively, the socket 40 may, as shown, be defined in part by a retaining member 48 spaced in opposition to the interior of the annular sidewall 42 and generally sized and shaped to receive the interior of an end of the housing 12. In this example, the socket 40 generally constrains translational travel of the housing 12 relative to the end cap 20. One or more shoulder surfaces 50 may additionally be defined at a distal portion of the socket 40 to configure the socket 40 to generally constrain longitudinal travel of the housing 12 relative to the end cap 20. The shoulder surfaces 50 may, as shown, extend from the annular sidewall 42.

In one example of the LED-based light 10, one or both of the sockets 40 defined by the end caps 20 can be shaped and sized to receive an end of the housing 12 with play permissive of small amounts of translational travel of the housing 12 relative to the end cap 20, of small amounts of longitudinal travel of the housing 12 relative to the end cap 20, or both. The play, for instance, may accommodate differing amounts of thermal expansion between the housing 12 and the support 36 to which the end caps 20 are attached. In other examples of the LED-based light 10, it will be understood that one or both of the sockets 40 defined by the end caps 20 can be shaped and sized to receive an end of the housing 12 substantially without play.

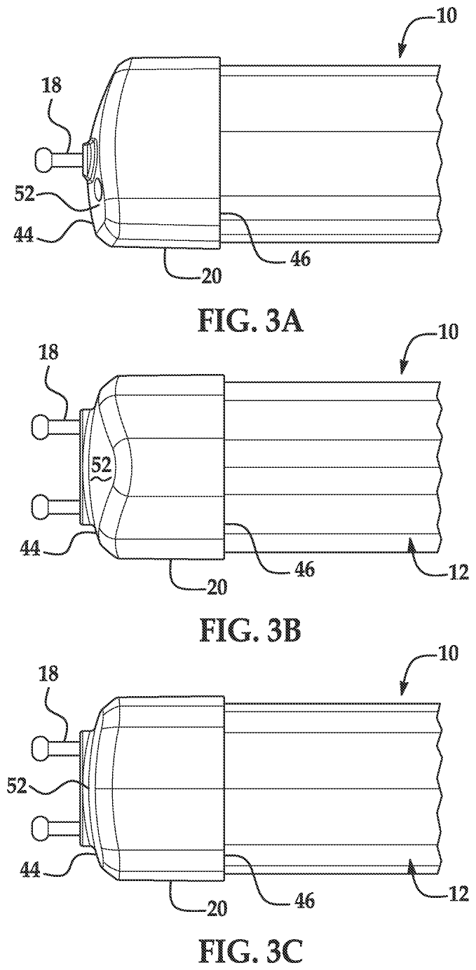

With reference to FIGS. 3A-3C, in the illustrated example of the LED-based light 10, the closed end 44 of one or both of the end caps 20 can define one or more tapered surfaces 52. As shown, the tapered surfaces 52 are tapered away from the closed end 44 and towards the remainder of the end cap 20 and the LED-based light 10.

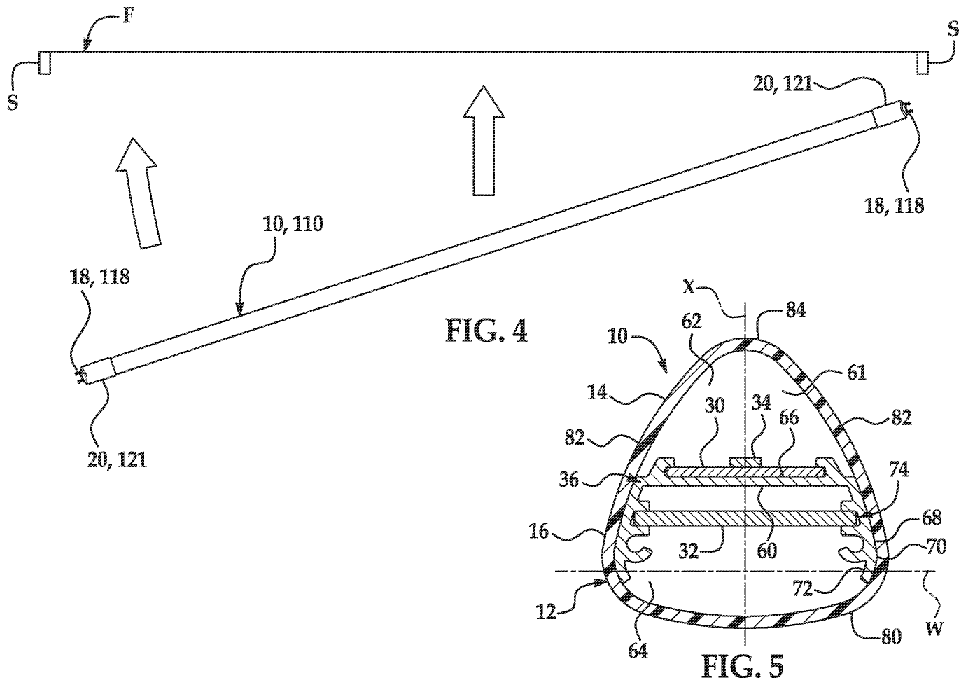

The tapered surfaces 52 may, for example, facilitate installation of the LED-based light 10. As shown with additional reference to FIG. 4, the LED-based light 10 may be installed in a light fixture F with a pair of opposing sockets S each adapted for physical engagement with the electrical connector 18 carried by an end cap 20. To install the LED-based light 10 in the light fixture F, typically, after one of the end caps 20 is connected to one of the sockets S, the remainder of the LED-based light 10 is swung towards the light fixture F to position the other end cap 20 near the other socket S for connection. The tapered surfaces 52 may facilitate installation of the LED-based light 10 by preventing either or both of the end caps 20 from hanging up on the sockets S.

The tapered surfaces 52 may be included on one, some or all of the portions of the closed end 44 bordering the electrical connector 18. In the illustrated example, each of the portions of the closed end 44 bordering the electrical connector 18 is includes a tapered surface 52 tapered away from the closed end 44 and towards the remainder of the end cap 20 and the LED-based light 10, giving the closed end 44 of the end cap 20 a generally domed shaped configuration. In particular, the tapered surfaces 52 are tapered at a corner of the end cap 20 that is opposite the base of the housing 12.

With additional reference to FIG. 5, the support 36 includes an elongate planar portion 60 arranged across the inside of the housing 12, giving the housing 12 a generally bipartite configuration, splitting cavity 61 into a first cavity 62 defined between the planar portion 60 of the support 36 and the lens 14, and a second cavity 64 defined between the planar portion 60 of the support 36 and the lower portion 16 of the housing 12.

As shown, the planar portion 60 defines an LED mounting surface 66 for supporting the LED circuit board 30 across the inside of the housing 12. The LED mounting surface 66 can be substantially flat, so as to support a flat underside of the LED circuit board 30 opposite the LEDs 34. The LED circuit board 30 is positioned within the first cavity 62 and adjacent the lens 14, such that the LEDs 34 of the LED circuit board 30 are oriented to illuminate the lens 14.

The support 36 may additionally include opposed elongate sidewalls 68 extending from the planar portion 60 and at least partially in contact with the housing 12. The outer walls 68 can be outboard edges 68 extending away from the planar portion 60. The outboard edges 68 each define a radially outer portion 70 and a radially inner portion 72. As shown, in each of the outboard edges 68, the radially outer portion 70 may have one or more areas shaped to correspond to the contour of the interior of the housing 12. These one or more areas at the radially outer portion 70 may be a continuous area shaped to correspond to the contour of the interior of the housing 12, or, may be discontinuous areas shaped to correspond to the contour of the interior of the housing 12. These one or more areas at the radially outer portion 70 may, for example, engage the interior of the housing 12 to support, in whole or in part, the housing 12.

The support 36 may be constructed from a thermally conductive material such as aluminum and configured as a heat sink to enhance dissipation of heat generated by the LEDs 34 during operation to an ambient environment surrounding the LED-based light 10. For instance, in the example LED-based light 10, the LED mounting surface 66 may support the flat underside of the LED circuit board 30 opposite the LEDs 34 in thermally conductive relation, and the one or more areas at the radially outer portion 70 in each of the outboard edges 68 shaped to correspond to the contour of the interior of the housing 12 may engage the interior of the housing 12 in thermally conductive relation, to define a thermally conductive heat transfer path from the LEDs 34 to the LED mounting surface 66 and the remainder of the support 36 through the LED circuit board 30, and to the ambient environment surrounding the LED-based light 10 through the outboard edges 68 of the support 36 and the housing 12.

Optionally, if the support 36 is constructed from an electrically conductive material, the housing 12 can be made from an electrically insulative material. In this configuration, the housing 12 can isolate the support 36 from the ambient environment surrounding the LED-based light 10 from a charge occurring in the support 36 as a result of, for instance, a parasitic capacitive coupling between the support 36 and the LED circuit board 30 resulting from a high-frequency starting voltage designed for starting a conventional fluorescent tube being provided to the LED-based light 10.

The power supply circuit board 32 may, as shown, be positioned within the second cavity 64, although it will be understood that the power supply circuit board 32 may also be positioned in other suitable locations, such as within one or both of the end caps 20 or external to the LED-based light 10. As shown, the power supply circuit board 32 may be supported across the inside of the housing 12. The interior of the housing 12 or the support 36 can include features for supporting the power supply circuit board 32. For instance, in the illustrated example of the LED-based light 10, the outboard edges 68 of the support 36 define opposing channels 74 configured to slidably receive outboard portions of the power supply circuit board 32. It will be understood that the channels 62 are provided as a non-limiting example and that the power supply circuit board 32 may be otherwise and/or additionally supported within the second cavity 64.

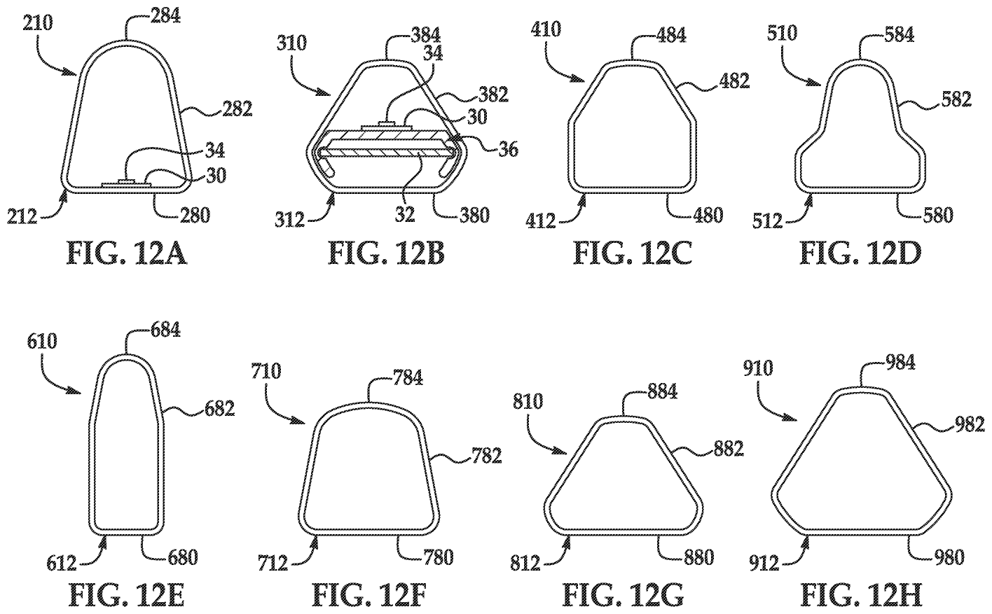

In one example of the LED-based light 10, referring to FIG. 5, the housing 12 may have a longitudinal axis and a vertical axis X, the housing defining the cavity 61. The cavity 61 can have a width that varies along the vertical axis X, the width including a greatest width W below a vertical center of the vertical axis X. As illustrated in FIG. 5, for example, the housing 12 may have a generally triangular cross sectional profile. The triangular cross sectional profile may be equilateral, as depicted in the figures, or can be isosceles. As shown in FIG. 5, the housing 12 includes a base 80 and opposing outer walls 82 extending from the base 80 and canted towards one another. The outer walls 82 can meet at a rounded crown 84 connecting the outer walls 82. The rounded crown 84 can include any similar shape as shown in FIG. 5, including those shown in FIGS. 12A-12H. In this example of the LED-based light 10, the lens 14 is formed by the rounded crown 84 and at least a portion of the opposing outer walls 82.

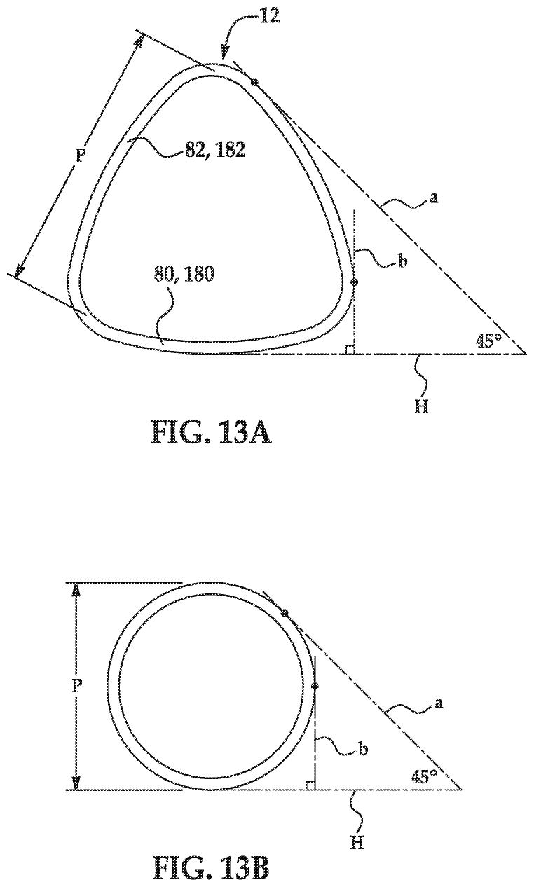

As illustrated in FIG. 13A, the housing 12 can be configured so that, with the base 80 extending substantially along a horizontal H, each of the two canted outer walls 82 have a profile P such that greater than or equal to 30% of the profile is between a line a tangent to the profile P and 45° from horizontal H and a line b tangent to the profile P and 90° from the horizontal H. This is distinguishable from other profiles. As a non-limiting example, FIG. 13B illustrates a conventional circular housing, the circular housing having a profile P such that 25% of the profile P is between a line a tangent to the profile P and 45° from horizontal H and a line b tangent to the profile P and 90° from the horizontal H.

The generally triangular cross sectional profile of the housing 12 of the LED-based light 10 may allow, for example, for a wider second cavity 64 defined between the planar portion 60 of the support 36 and the lower portion 16 of the housing 12 as compared to an otherwise similar LED-based light with a lower portion formed from a housing having a circular cross sectional profile. This may among other things, for instance, accommodate a wider power supply circuit board 32 within the second cavity 64.

The generally triangular cross sectional profile of the housing 12 of the LED-based light 10 may also allow, for example, for a different optical redistribution by the lens 14 of the light emanating from the LEDs 34 as compared to the optical redistribution, if any, of the light emanating from the LEDs in an otherwise similar LED-based light with a lens formed from a housing having a circular cross sectional profile. Although the description follows with general reference to the spatial aspects of light, it will be understood that the lens 14 of the LED-based light 10 could be additionally configured to modify, for instance, the spectral aspects of the light emanating from the LEDs 34.

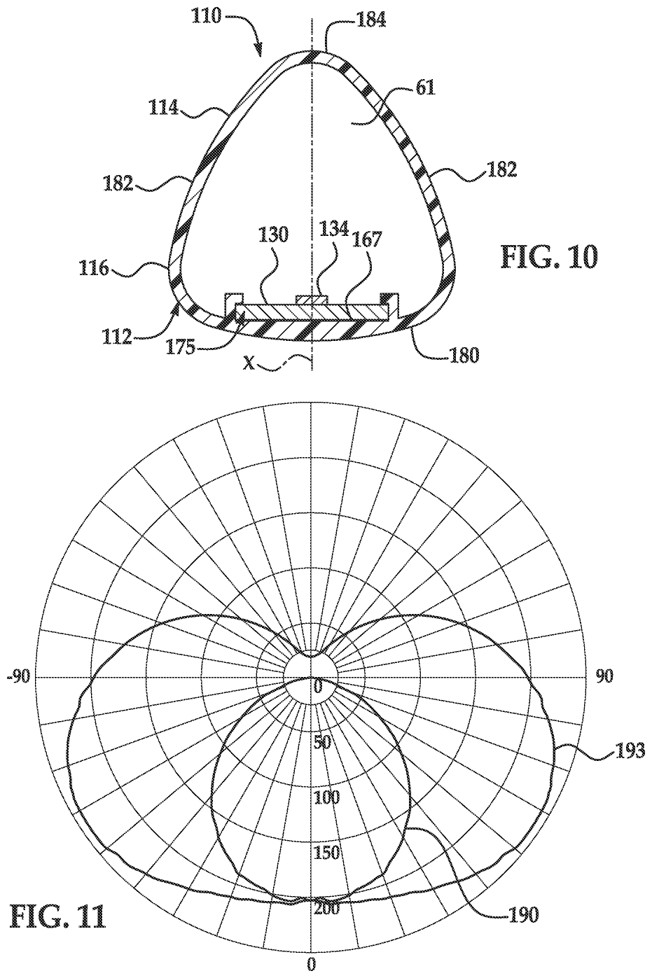

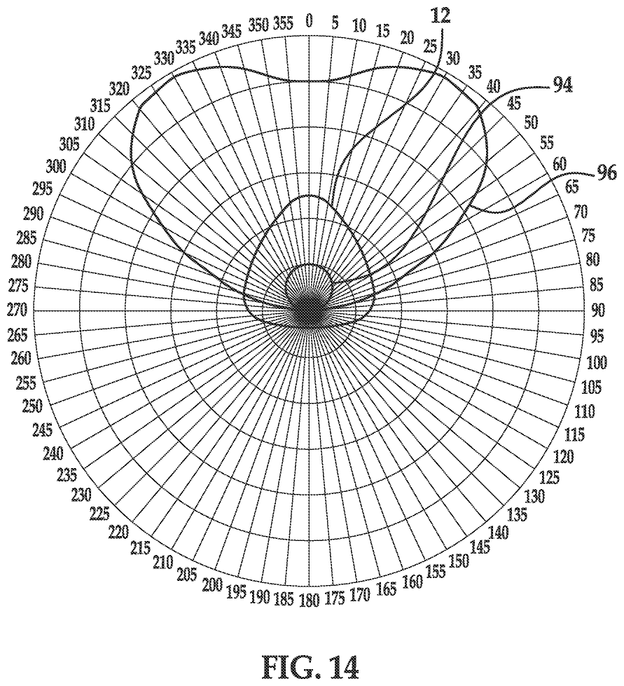

FIG. 14 illustrates the housing 12 and a light profile 94 of the output of the LED. Profile 96 represents the intensity of the light projected onto the internal surfaces of the housing shown in FIGS. 5 and 10. The diffusion in the housing 12 combined with the intensity of the light striking the interior surface of the housing 12 determines the lighting profile as observed from outside the LED-based light. The profile 96 is determined from a combination of the angle of the surface at a given point relative to the LED and the distance of that given point from the LED. The intensity of the LED source is greatest at 0 degrees; however, the distance of the lens at 0 degrees is large and thus the “beam” coming from the LED is spread across a greater portion of the lens, reducing the point intensity.

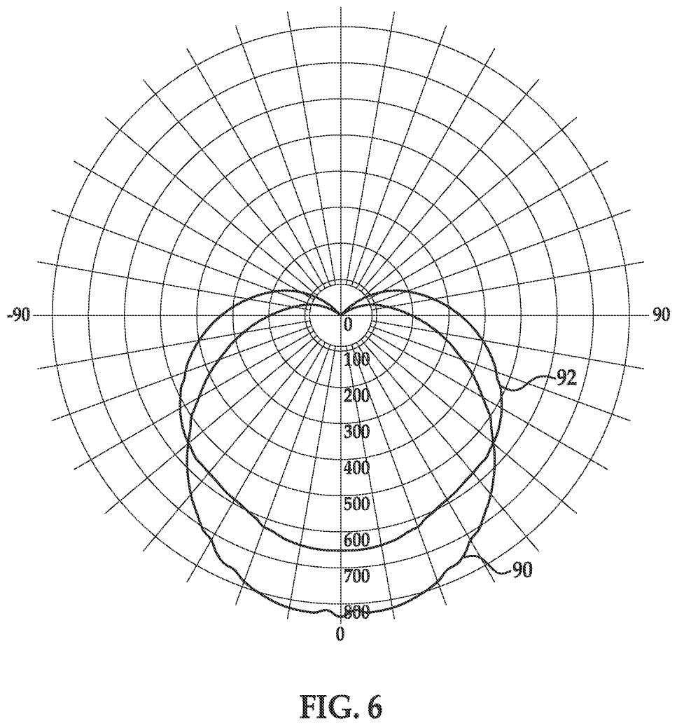

The light emanating from both the LEDs 34 in the LED-based light 10 and the LEDs in the otherwise similar LED-based light with a lens formed from a housing having a circular cross sectional profile may be generally directional. In the otherwise similar LED-based light, the generally directional nature of the LEDs may be substantially maintained as the light is transmitted through the lens. An example of a resulting light distribution 90 for the otherwise similar LED-based light is shown in FIG. 6. As shown, for this LED-based light, the light emanating from the LEDs is generally directionally distributed in a direction normal to the LEDs (i.e., along 0°), and little if any of the light emanating from the LEDs is distributed in a direction opposite the LEDs.

In the LED-based light 10, the lens 14 may generally be configured to redistribute some or all of the light emanating from the LEDs 34 away from the direction normal to the LEDs 34. The two canted outer walls 82 can be formed of a light transmitting material and configured to maximize an illuminated section of the housing 12 that faces horizontal. For example, as shown in the light distribution 92 in FIG. 6, the light transmitted from the lens 14 may have a “batwing” configuration, or, a configuration with relatively more distribution of light away from 0° as compared to the light distribution 90 achieved with the otherwise similar LED-based light with a lens formed from a housing having a circular cross sectional profile.

In the illustrated example construction of the LED-based light 10, for instance, the lens 14 is formed by a rounded crown 84 connecting the opposing upright outer walls 82 and some or all of the opposing outer walls 82. It has been found that both increasing cant of the opposing outer walls 82 towards one another and decreasing distance between the opposing outer walls 82 are effective not only to redistribute relatively more of the light emanating from the LEDs 34 away from 0° and in a direction opposite the LEDs, but also to increase overall optical efficiency of the lens 14.

The LED-based light 10 can include other features for distributing light produced by the LEDs 34. For example, the lens 14 can be manufactured with structures to collimate light produced by the LEDs 34. The light collimating structures can be formed integrally with the lens 14, for example, or can be formed in a separate manufacturing step. In addition to or as an alternative to manufacturing the lens 14 to include light collimating structures, a light collimating film can be applied to the exterior of the lens 14 or placed in the housing 12.

In yet other embodiments, the LEDs 34 can be over molded or otherwise encapsulated with light transmitting material configured to distribute light produced by the LEDs 34. For example, the light transmitting material can be configured to diffuse, refract, collimate and/or otherwise distribute the light produced by the LEDs 34. The over molded LEDs 34 can be used alone to achieve a desired light distribution for the LED-based light 10, or can be implemented in combination with the lens 14 and/or films described above.

The above described or other light distributing features can be implemented uniformly or non-uniformly along a length and/or circumference of the LED-based light 10. These features are provided as non-limiting examples, and in other embodiments, the LED-based light 10 may not include any light distributing features.

The LED circuit board 30 can include at least one LED 34, a plurality of series-connected or parallel-connected LEDs 34, an array of LEDs 34 or any other arrangement of LEDs 34. Each of the illustrated LEDs 34 can include a single diode or multiple diodes, such as a package of diodes producing light that appears to an ordinary observer as coming from a single source. The LEDs 34 can be surface-mount devices of a type available from Nichia, although other types of LEDs can alternatively be used. For example, the LED-based light 10 can include high-brightness semiconductor LEDs, organic light emitting diodes (OLEDs), semiconductor dies that produce light in response to current, light emitting polymers, electro-luminescent strips (EL) or the like. The LEDs 34 can emit white light. However, LEDs that emit blue light, ultra-violet light or other wavelengths of light can be used in place of or in combination with white light emitting LEDs 34.

The orientation, number and spacing of the LEDs 34 can be a function of a length of the LED-based light 10, a desired lumen output of the LED-based light 10, the wattage of the LEDs 34, a desired light distribution for the LED-based light 10 and/or the viewing angle of the LEDs 34.

The LEDs 34 can be fixedly or variably oriented in the LED-based light 10 for facing or partially facing an environment to be illuminated when the LED-based light 10 is installed in a light fixture. Alternatively, the LEDs 34 can be oriented to partially or fully face away from the environment to be illuminated. In this alternative example, the LED-based light 10 and/or a light fixture for the LED-based light 10 may include features for reflecting or otherwise redirecting the light produced by the LEDs into the environment to be illuminated.

For a 48″ LED-based light 10, the number of LEDs 34 may vary from about thirty to three hundred such that the LED-based light 10 outputs between 1,500 and 3,000 lumens. However, a different number of LEDs 34 can alternatively be used, and the LED-based light 10 can output any other amount of lumens.

The LEDs 34 can be arranged in a single longitudinally extending row along a central portion of the LED circuit board 30 as shown, or can be arranged in a plurality of rows or arranged in groups. The LEDs 34 can be spaced along the LED circuit board 30 and arranged on the LED circuit board 30 to substantially fill a space along a length of the lens 14 between end caps 20 positioned at opposing longitudinal ends of the housing 12. The spacing of the LEDs 34 can be determined based on, for example, the light distribution of each LED 34 and the number of LEDs 34. The spacing of the LEDs 34 can be chosen so that light output by the LEDs 34 is uniform or non-uniform along a length of the lens 14. In one implementation, one or more additional LEDs 34 can be located at one or both ends of the LED-based light 10 so that an intensity of light output at the lens 14 is relatively greater at the one or more ends of the LED-based light 10. Alternatively, or in addition to spacing the LEDs 34 as described above, the LEDs 34 nearer one or both ends of the LED-based light 10 can be configured to output relatively more light than the other LEDs 34. For instance, LEDs 34 nearer one or both ends of the LED-based light 10 can have a higher light output capacity and/or can be provided with more power during operation.

The power supply circuit board 32 has power supply circuitry configured to condition an input power received from, for example, the light fixture through the electrical connector 18, to a power usable by and suitable for the LEDs 34. In some implementations, the power supply circuit board 32 can include one or more of an inrush protection circuit, a surge suppressor circuit, a noise filter circuit, a rectifier circuit, a main filter circuit, a current regulator circuit and a shunt voltage regulator circuit. The power supply circuit board 32 can be suitably designed to receive a wide range of currents and/or voltages from a power source and convert them to a power usable by the LEDs 34.

As shown, the LED circuit board 30 and the power supply circuit board 32 are vertically opposed and spaced with respect to one another within the housing 12. The LED circuit board 30 and the power supply circuit board 32 can extend a length or a partial length of the housing 12, and the LED circuit board 30 can have a length different from a length of the power supply circuit board 32. For example, the LED circuit board 30 can generally extend a substantial length of the housing 12, and the power supply circuit board 32 can extend a partial length of the housing. However, it will be understood that the LED circuit board 30 and/or the power supply circuit board 32 could be alternatively arranged within the housing 12, and that the LED circuit board 30 and the power supply circuit board 32 could be alternatively spaced and/or sized with respect to one another.

The LED circuit board 30 and the power supply circuit board 32 are illustrated as elongate printed circuit boards. Multiple circuit board sections can be joined by bridge connectors to create the LED circuit board 30 and/or power supply circuit board 32. Also, other types of circuit boards may be used, such as a metal core circuit board. Further, the components of the LED circuit board 30 and the power supply circuit board 32 could be in a single circuit board or more than two circuit boards.

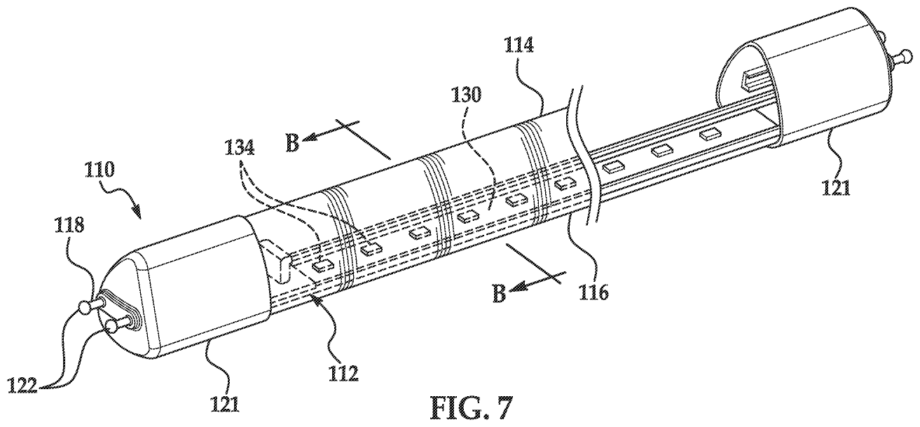

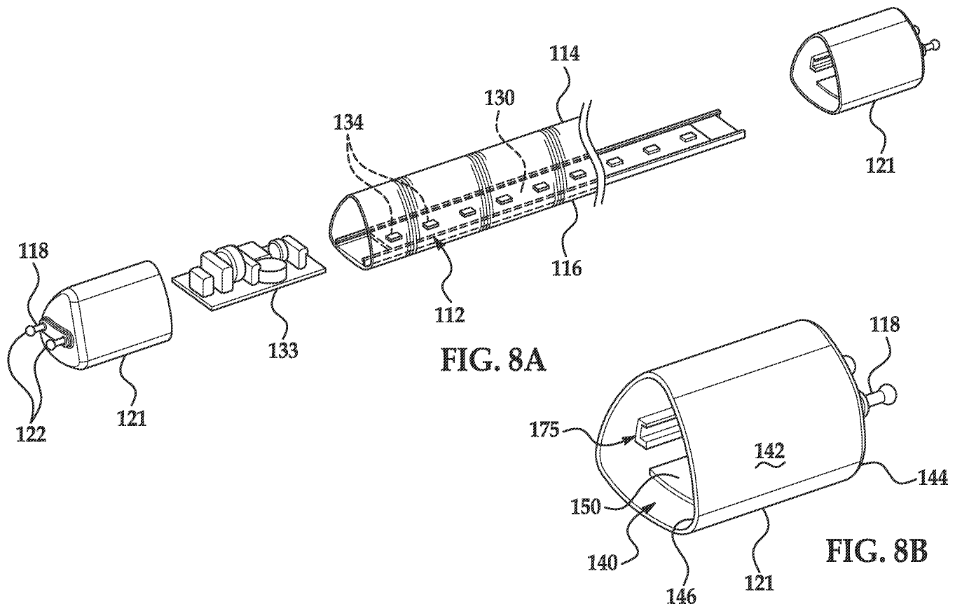

A second example of an LED-based light 110 for replacing a conventional light in a standard light fixture is illustrated in FIGS. 7 and 8. Components in the LED-based light 110 with like function and/or configuration as components in the LED-based light 10 are designated similarly, with 100-series designations instead of the 10-series designations for the LED-based light 10. For brevity, the full descriptions of these components is not repeated, and only the differences from the LED-based light 10 to the LED-based light 110 are explained below.

The LED-based light 110, similarly to the LED-based light 10, includes a housing 112 and has a pair of end caps 121 positioned at the ends of the housing 112. An LED circuit board 130 including LEDs 134 and a power supply circuit board 133 are arranged within the housing 112. The housing 112 of the LED-based light 110 can generally define a single package sized for use in a standard fluorescent light fixture, as described above.

Compared to the LED-based light 10, the LED-based light 110 does not include the support 36 arranged within the housing 112 to support the LED circuit board 130 and the power supply circuit board 133 across the inside of the housing 112.

In the LED-based light 110, with reference to FIG. 8, each of the end caps 121 defines a socket 140 sized and shaped to receive and retain an end of the housing 112. In the illustrated example, each of the end caps 121 is generally tubular, with an annular sidewall 142, a first, closed end 144 bordering the electrical connector 118 and a second, open end 146 in communication with the socket 140. The socket 140 may, as shown, be defined in part by the interior of the annular sidewall 142. According to this example, the interior of the annular sidewall 142 is generally sized and shaped to receive and circumscribe the exterior of an end of the housing 112. An exterior surface of each end cap 121 can be configured to be flush with an exterior surface of the housing 112. One or more shoulder surfaces 150 may be defined at a distal portion of the socket 140 to configure the socket 140 to generally constrain longitudinal travel of the housing 112 relative to the end cap 121. The shoulder surfaces 150 may, as shown, extend from the annular sidewall 142. The end caps 121 may, for example, be attached to the opposing ends of the housing 112 by threaded fasteners or an adhesive, for example.

In the LED-based light 110, the power supply circuit board 133 extends a partial length of the LED-based light 110, and may be arranged in one or both the end caps 121. In the illustrated example, at least one of the end caps 121 is elongated compared to the end caps 20 of the LED-based light 10 and generally sized and shaped to receive the power supply circuit board 133. The power supply circuit board 133 may, as shown, be a singular package and housed in only one of the end caps 121. Alternatively, it will be understood that the power supply circuit board 133 could include other packages housed in the other of the end caps 121, for example, or otherwise in the housing 112. In some implementations, only the end caps 121 housing the power supply circuit board 133 could be elongated compared to the end caps 20 of the LED-based light 10. Optionally, however, as generally shown, both of end caps 121 may be matching elongated end caps 121 regardless of whether they each house the power supply circuit board 133.

As shown, the power supply circuit board 133 may be supported across the inside of an end cap 121. The interior of the annular outer walls 142 of the end cap 121 can include features for supporting the power supply circuit board 133. For instance, in the illustrated example of the LED-based light 110, interior of the annular outer walls 142 of the end cap 121 define opposing channels 175 configured to slidably receive outboard portions of the power supply circuit board 133. It will be understood that the channels 163 are provided as a non-limiting example and that the power supply circuit board 133 may be otherwise and/or additionally supported across the inside of an end cap 121 or otherwise within the end cap 121.

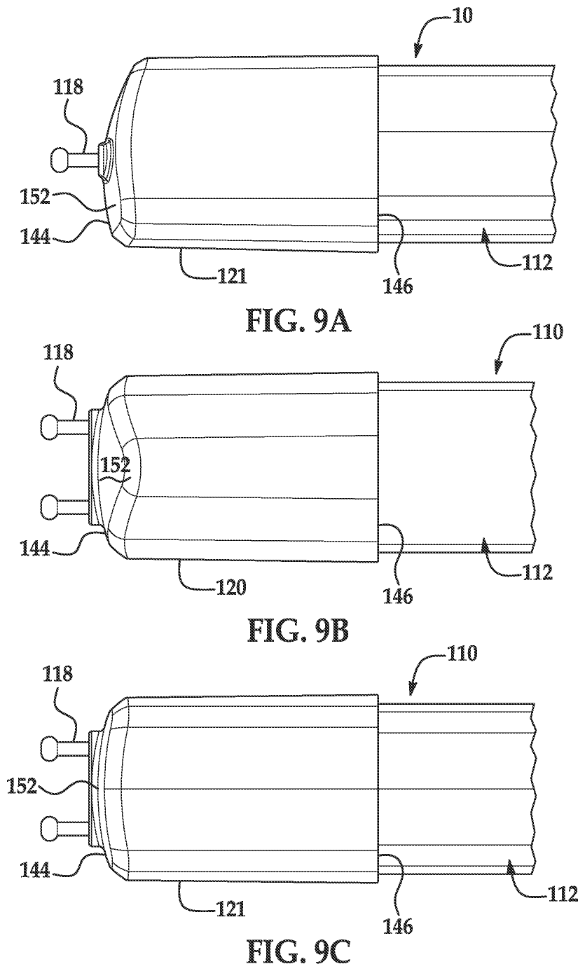

As described above for the LED-based light 10, with reference to FIG. 9, in the illustrated example of the LED-based light 110, the closed end 144 of one or both of the end caps 121 can define one or more tapered surfaces 152 facilitating installation of the LED-based light 110 by preventing either or both of the end caps 121 from hanging up on the sockets S of a light fixture F, as described above with reference to FIG. 4.

With additional reference to FIG. 10, in the LED-based light 110, without the support 36 of the LED-based light 10 arranged within the housing 112, the housing 112 defines a cavity 163 between the lens 114 and the lower portion 116 of the housing 112. With the power supply circuit board 133 arranged in one or both the end caps 121, the LED circuit board 130 may be arranged at the base 180 of the housing 112. As shown, base 180 defines an LED mounting surface 167 for supporting the LED circuit board 130. The LED mounting surface 167 can be substantially flat, so as to support a flat underside of the LED circuit board 130 opposite the LEDs 134. The LED circuit board 130 is positioned within the cavity 163 and facing the lens 114, such that the LEDs 134 of the LED circuit board 130 are oriented to illuminate the lens 114.

To enhance dissipation of heat generated by the LEDs 134 during operation to an ambient environment surrounding the LED-based light 110, in the example LED-based light 110, the LED mounting surface 167 may support the flat underside of the LED circuit board 130 opposite the LEDs 134 in thermally conductive relation to define a thermally conductive heat transfer path from the LEDs 134 to the LED mounting surface 167, and to the ambient environment surrounding the LED-based light 110 through the housing 112. Optionally, the housing 112 can be made from an electrically insulative material. In this configuration, the housing 112 can isolate the LED circuit board 130 from the ambient environment surrounding the LED-based light 110 from a charge occurring in the LED circuit board 130 resulting from a high-frequency starting voltage designed for starting a conventional fluorescent tube being provided to the LED-based light 110.

In one example of the LED-based light 110, the housing 112 may have a generally triangular cross sectional profile, as described above for the housing 12 of the LED-based light 10. As shown in FIG. 10, the housing 112 includes a base 180 and opposing upright outer walls 182 extending from the base 180 and canted towards one another. The housing 112 can include a rounded crown 184 connecting the upright outer walls 182.

As illustrated in FIG. 13A, the housing 12 can be configured so that, with the base 180 extending substantially along a horizontal H, each of the two canted outer walls 182 have a profile P such that greater than or equal to 30% of the profile is between a line a tangent to the profile P and 45° from horizontal H and a line b tangent to the profile P and 90° from the horizontal H. This is distinguishable from other profiles. As a non-limiting example, FIG. 13B illustrates a conventional circular housing, the circular housing having a profile P such that 25% of the profile P is between a line a tangent to the profile P and 45° from horizontal H and a line b tangent to the profile P and 90° from the horizontal H.

The generally triangular cross sectional profile of the housing 112 of the LED-based light 110 may also allow, for example, for a different optical redistribution by the lens 114 of the light emanating from the LEDs 134 as compared to the optical redistribution, if any, of the light emanating from the LEDs in an otherwise similar LED-based light with a lens formed from a housing having a circular cross sectional profile. Although the description follows with general reference to the spatial aspects of light, it will be understood that the lens 114 of the LED-based light 110 could be additionally configured to modify, for instance, the spectral aspects of the light emanating from the LEDs 134.

The light emanating from both the LEDs 134 in the LED-based light 110 and the LEDs in the otherwise similar LED-based light with a lens formed from a housing having a circular cross sectional profile may be generally directional. In the otherwise similar LED-based light, the generally directional nature of the LEDs may be substantially maintained as the light is transmitted through the lens. An example of a resulting light distribution 190 for the otherwise similar LED-based light is shown in FIG. 11. As shown, for this LED-based light, the light emanating from the LEDs is generally directionally distributed in a direction normal to the LEDs (i.e., along 0°), and little if any of the light emanating from the LEDs is distributed in a direction opposite the LEDs.

In the LED-based light 110, the lens 114 may generally be configured to redistribute some or all of the light emanating from the LEDs 134 away from the direction normal to the LEDs 134. For example, as shown in the light distribution 193 in FIG. 11, the light transmitted from the lens 114 may have a “batwing” configuration, or, a configuration with relatively more distribution of light away from 0° as compared to the light distribution 190 achieved with the otherwise similar LED-based light with a lens formed from a housing having a circular cross sectional profile. Further, due in part to the arrangement of the LED circuit board 130 at the base 180 of the housing 112, the light transmitted from the lens 114 may have a configuration with relatively more distribution of light away from 0° as compared to the light distribution 92 achieved with the LED-based light 10.

Alternative examples of LED-based lights 210, 310, 410, 510, 610, 710, 810, 910, where the lenses 214, 314, 414, 514, 614, 714, 814, 914 are formed by a rounded crown 284, 384, 484, 584, 684, 784, 884, 984 and adjoining distal portions of opposing canted outer walls 282, 382, 482, 582, 682, 782, 882, 982, are shown in FIGS. 12A-H. In these examples, the configurations of the housings are substantially as described above for the LED-based light 10 and the LED-based light 110. The examples may accommodate the support of the LED circuit boards as described with respect to LED-based lights 10, 110 using the support 36 as described or the base or bottom surface of the housing 112. By means of example only, FIG. 12A illustrates the LED circuit board 30 supported by the base surface 280 of the housing 212. By means of example only, FIG. 12B illustrates the LED circuit board 30 supported by the support 36, with the support 36 also supporting the power supply circuit board 32.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1.-20. (canceled)

21. A lighting device comprising:
an elongate tubular housing having longitudinal axis,
wherein the housing defines an exterior of the lighting device and a cavity,
wherein the housing comprises three interconnected wall portions, and
wherein each of the wall portions defines a substantially identical curved profile in cross-section orthogonal to the longitudinal axis;
a circuit board positioned within the cavity;
a plurality of light emitting diodes (LEDs) positioned on the circuit board;
an end cap positioned at an end of the housing, wherein the end cap comprises:
a first end configured to receive the end of the housing,
a second end comprising a first surface and a second surface surrounds the first surface, wherein each of the first surface and the second surface are tapered towards the second end, and
a connector protruding from the second end,
wherein the end cap defines a first rounded corner, a second rounded corner, and a third rounded corner, and
wherein a tapering of the first surface in a first region proximate to the first corner is greater than (i) a tapering of the first surface in a second region proximate to the second corner and (ii) a tapering of the first surface in a third region proximate to the third corner.

22. The lighting device of claim 21, wherein a tapering of the second surface in the first region proximate to the first corner is greater than (i) a tapering of the second surface in the second region proximate to the second corner and (ii) a tapering of the second surface in the third region proximate to the third corner.

23. The lighting device of claim 21, wherein the plurality of LEDs comprises at least one of a semiconductor LED, an organic light emitting diode (OLEDs), a semiconductor die, a light emitting polymer, or an electro-luminescent strip.

24. The lighting device of claim 21, wherein the end cap defines a pair of opposing channels at the first end of the end cap, and wherein the pair of opposing channels is configured to slidably receive the circuit board.

25. The lighting device of claim 21, wherein the each of the rounded corners of the end cap corresponds to a respective intersection between respective pairs of the wall portions.

26. The lighting device of claim 25, wherein the circuit board faces the first rounded corner.

27. The lighting of claim 21, wherein the end cap comprises a shoulder surface extending towards the first end of the end cap, wherein the shoulder surface is configured to constrain a relative longitudinal movement of the housing relative to the end cap.

28. The lighting device of claim 27, wherein the shoulder surface extends from an annular side wall of the end cap.

29. The lighting device of claim 21, wherein the wall portions form a rounded triangle in cross-section orthogonal to the longitudinal axis.

30. The lighting device of claim 21, wherein the wall portions form a rounded equilateral triangle in cross-section orthogonal to the longitudinal axis.

31. The lighting device of claim 21, wherein the end cap is secured to the housing by one or more threaded fasteners.

32. The lighting device of claim 21, wherein the end cap is secured to the housing by adhesive.
